(19) United States
(12) Patent Application Publication
(10) Pub. No.: US 2016/0071182 A1
(43) Pub. Date: Mar. 10, 2016

(54) MULTIMEDIA RECOMMENDATION BASED ON ARTIST SIMILARITY

(71) Applicant: Microsoft Corporation, Redmond, WA (US)

(72) Inventors: Paul Nogues, Vanves (FR); Manuel Millot, Saint-Germain-en-Laye (FR); Buu-Minh Ta, Paris (FR); Guillaume Convers, Gentilly (FR); Fathallah Labhalla, Montigny-Le-Bretonneux (FR); Sebastien Lecomte, Montigny-Le-Bretonneux (FR); Herve Ndoguefouba, Cergy (FR)

(21) Appl. No.: 14/483,025

(22) Filed: Sep. 10, 2014

(51) Int. Cl. G06Q 30/06; G06F 3/0484; G06F 17/30

(52) U.S. Cl. CPC G06Q 30/0631; G06F 17/30029; G06F 3/04842; G06Q 30/0641

(57) ABSTRACT

One or more multimedia recommendation candidates are identified for a user. For each of the one or more multimedia recommendation candidates, a similarity between a multimedia artist associated with that multimedia recommendation candidate and a preferred artist of the user is determined That multimedia recommendation candidate is recommended to the user if the similarity exceeds a threshold.

### BACKGROUND

In addition to making multimedia available for purchase, a digital multimedia storefront may recommend multimedia to users. Some digital storefronts recommend newly released multimedia. Other digital storefronts attempt to recommend multimedia determined to align with user preference, for example by utilizing human input to classify multimedia.

### SUMMARY

Examples are disclosed herein that relate to multimedia recommendation. For each of one or more multimedia recommendation candidates, a similarity between a multimedia artist associated with that multimedia recommendation candidate and a preferred artist of the user is determined The multimedia recommendation candidate is recommended to the user if the similarity exceeds a threshold.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example multimedia storefront.

FIG. 2 shows a graphical representation of an example multimedia consumption history for a given user.

FIG. 3 shows an example plot of user-to-artist affinities.

FIG. 4 shows a graphical representation of an example multimedia consumption history including user-to-artist affinities.

FIG. 5 illustrates an example of the formation of multimedia artist vectors and determination of artist-to-artist similarity.

FIGS. 6A and 6B are a flowchart illustrating a method of recommending multimedia.

FIG. 7 schematically shows an example computing device.

### DETAILED DESCRIPTION

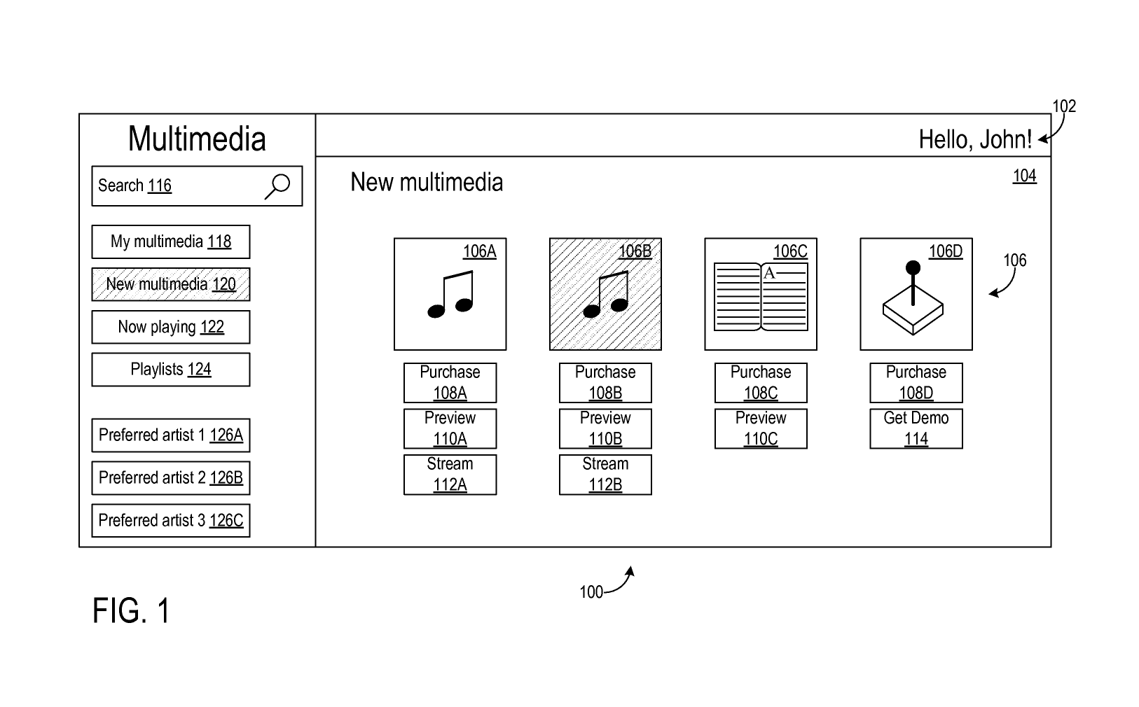

FIG. 1 shows an example multimedia storefront 100. Storefront 100 is configured to recommend new multimedia releases determined to align with a user's multimedia preferences by determining the similarity between multimedia artists the user prefers and the artists associated with the new multimedia releases. As used herein, the term artist can be used to refer to different parties responsible for the creation of different types of media content. As nonlimiting examples, the artist may be the author of a book; the composer, producer, and/or recording musicians of a musical album; the actors, directors, producers, and/or studio of a movie; or the game developers, game studio, and/or game franchise of a video game.

Storefront 100 is presented in a graphical user interface (GUI) and optionally can be tailored to a given user accessing the storefront. As such, storefront 100 includes a greeting 102 indicating identification of the user and the user's name. The user may be identified based on unique login credentials, for example.

Storefront 100 includes a new multimedia window 104 that presents newly released multimedia identified as being in alignment with the determined multimedia preferences of the logged-in user. In the depicted example, four newly-released multimedia items 106 are presented in window 104. Multimedia items 106 may be of virtually any multimedia type, including but not limited to music (e.g., songs, albums, etc.), video (e.g., movies), applications (e.g., videogames), books, images, etc. Each multimedia item 106 may have associated therewith one or more GUI objects configured to enable some functionality to be carried out with respect to that object. The particular GUI objects associated with a given multimedia item 106 may be determined based on the type of the given multimedia item. For example, multimedia item 106A may be a music album, in which case the object may have associated therewith a purchase GUI object 108A configured to initiate a purchase of the music album, a preview GUI object 110A configured to begin a preview (e.g., playback of the music album for a limited duration) of the music album, and a stream GUI object 112A configured to begin streaming the music album. Purchase GUI object 108A may cause multimedia item 106A to be downloaded to a local computing device operated by the logged-in user and with which storefront 100 is accessed and/or cause a digital rights management license to be updated so that the user can locally and/or remotely access the multimedia item on a permanent basis. Preview and stream GUI objects 110A and 112A may cause the multimedia item to be remotely streamed from a remote computing device and/or cause a digital rights management license to be updated so that the user can access the multimedia on a temporary or preview basis.

Similar and/or different GUI objects may be associated with the other multimedia items 106 presented in window 104. For example, multimedia item 106B may also be a music album, in which case the object has analogous purchase, preview, and stream GUI objects 108B, 110B, and 112B, each configured to respectively enable the functionalities of their counterpart GUI objects described above. In contrast, multimedia item 106C may be a book. Accordingly, multimedia item 106C may have associated therewith a purchase GUI object 108C and a preview GUI object 110C that enables display of limited excerpts from the book. Finally, multimedia item 106D may be a videogame, and have associated therewith a purchase GUI object 108D and a demo GUI object 114, which may enable the logged-in user to play a limited demo of the videogame, for example.

It will be understood that selection of the GUI objects (purchase GUI objects 108A-D, preview GUI objects 110A-C, stream GUI objects 112A and 112B, and demo GUI object 114) associated with multimedia items 106 may prompt their respective functionalities to be carried out. Selection of the GUI objects may be performed via user input through a suitable input device (e.g., mouse, game controller, microphone for detecting voice commands, camera for detecting gesture commands, etc.), and may cause execution of associated instructions that implement the associated functionality.

Multimedia storefront 100 may facilitate other functions in addition to those described above. For example, storefront 100 may include a search GUI object 116 configured to enable the logged-in user to search for multimedia according to criteria supplied by the user. In some implementations, searching may be specific to an instant window (e.g., window 104) being displayed in storefront 100. Alternatively or additionally, storefront 100 may include a my multimedia GUI object 118 configured to enable the logged-in user to visualize and access multimedia associated with the user—e.g., multimedia that the user purchased. Such multimedia may be stored locally and/or remotely. As shown, storefront 100 may include a new multimedia GUI object 120 whose selection prompts the display of window 104. In some implementations, storefront 100 may enable playback of multimedia, which may or may not leverage one or more external applications operable to play back multimedia. In these implementations, storefront 100 may include a now playing GUI object 122 configured to enable the logged-in user to consume multimedia currently being played back. Storefront 100 may include a playlists GUI object 124 configured to enable the logged-in user to access one or more lists of multimedia for convenient access to the listed multimedia. Finally, storefront 100 may include one or more preferred artist GUI objects 126 that each enable the logged-in user to access multimedia associated with that preferred artist.

It will be appreciated that multimedia storefront 100 is provided as an example and is not intended to be limiting in any way. Various modifications to storefront 100 are possible without departing from the scope of this disclosure. While multiple types of multimedia are shown as being recommended to the logged-in user in window 104, in other implementations a single multimedia type (e.g., music albums) may be recommended. In some examples, the logged-in user may specify the multimedia types that are recommended.

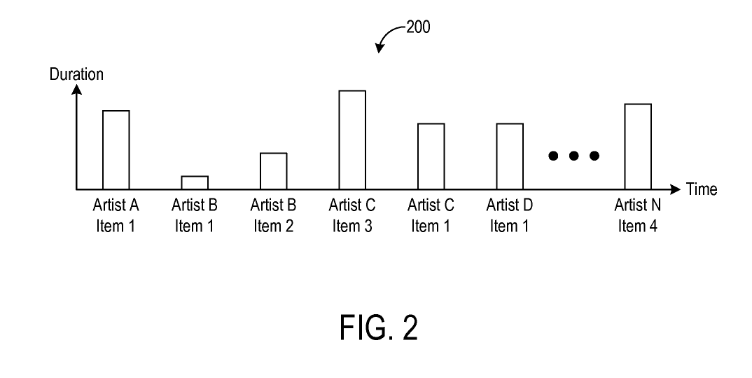

Storefront 100 may utilize a multimedia consumption history of the logged-in user to determine the multimedia preferences of the user and recommend multimedia based on those preferences. FIG. 2 graphically shows an example multimedia consumption history 200 for a given user (e.g., the logged-in user in FIG. 1). History 200 graphically represents the data that indicates the multimedia consumed by the user and various aspects of its consumption. History 200 may indicate, for example, the duration in which each multimedia item was played back throughout a suitable time interval (e.g., the past seven months). While shown as being collected on a per-multimedia item (e.g., per-music album) basis, user playback data may be recorded in other manners (e.g., on a per-artist basis). Other aspects of multimedia item consumption may be recorded, including but not limited to a frequency with which each item was consumed (e.g., number of times played back), a number of times each item was paused, skipped, etc. Multimedia items whose consumption is recorded in history 200 may have been purchased, previewed, streamed, demoed, and/or consumed via other means.

One or more artists preferred by the user may be identified from history 200. Preferred artists may be specifically identified by determining an affinity of the user for each artist for whom multimedia consumption data was recorded in multimedia consumption history 200.

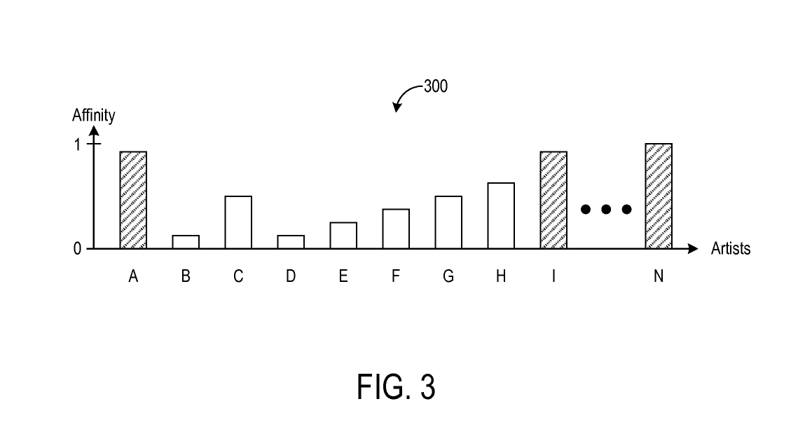

FIG. 3 shows an example plot 300 of user-to-artist affinities. Generally, an affinity of a user for an artist represents how prolifically the user has previously experienced multimedia created by the artist. In the depicted example, user-to-artist affinities are represented by a number from 0 to 1, where an affinity of 1 indicates a maximum user-to-artist affinity, and an affinity of 0 indicates a minimum user-to-artist affinity. Artists having an affinity that exceeds a threshold (e.g., 0.8) may be identified as a preferred artist, such as artists ‘A’, ‘I’, and ‘N’, for example. The affinity threshold may be adjustable in some examples, particularly if user-to-artist affinities are distributed relatively evenly. An increased affinity threshold, for example, may cause artists associated with more prolific consumption to be identified as preferred artists, while a decreased affinity threshold may lower the degree to which the prolificacy of consumption separates preferred artists from non-preferred artists.

Various data from multimedia consumption history 200 (FIG. 2) may be used to determine user-to-artist affinities in plot 300. For example, a user-to-artist affinity may increase as the number of times the user has consumed multimedia associated with the artist increases. Music albums created by artist ‘A’, for example, have been listened to by the user a relatively high number of times, leading to a relatively high user affinity for the artist. The relationship between number of times multimedia was consumed and affinity may be linear or assume various other suitable forms (e.g., quadratic, exponential, etc.). In some implementations, an affinity of the user for an artist may be increasingly weighted as a time since the user consumed multimedia associated with the artist decreases. In other words, the more recently the user consumed the artist's multimedia, the greater their associated affinity becomes. Multimedia created by artists ‘I’ and ‘N’, for example, was recently consumed, leading to high affinities for those artists. In some implementations, user-to-artist affinities may increase exponentially the more recently the artist's multimedia is consumed. Such an approach may increase the degree to which multimedia recommendation is responsive to the current multimedia preferences of the user as opposed to ephemeral indulgences in the past. However, artists for which the user has a high affinity but whose multimedia has not been consumed recently may nevertheless retain a relatively high affinity. For example, an artist whose multimedia is consumed more than a threshold number of times may be identified as a preferred artist regardless of the last time their multimedia was consumed. Artist ‘A’ is one example of such an artist. The threshold number of times may be adjusted in some examples, for example based on the average number of times the user has consumed multimedia for each artist. Alternative or additional mechanisms may be employed to identify preferred artists whose multimedia was not recently consumed, however.

Various types of filtering may be applied when determining a user's preferred artists. For example, consumption data in multimedia consumption history 200 (FIG. 2) associated with multimedia whose creators are not uniquely identified (e.g., identified as “various artists”) may be discarded when determining preferred artists. Other filtering may be applied—e.g., in order to remove duplicate or near-duplicate multimedia.

Thus, multimedia in alignment with a user's multimedia preferences may be recommended to the user by identifying the user's preferred artists based on their multimedia consumption history in this way. In some implementations, a respective set (e.g., one or more) of multimedia recommendation candidates may be identified for each preferred artist identified in the user's multimedia consumption history.

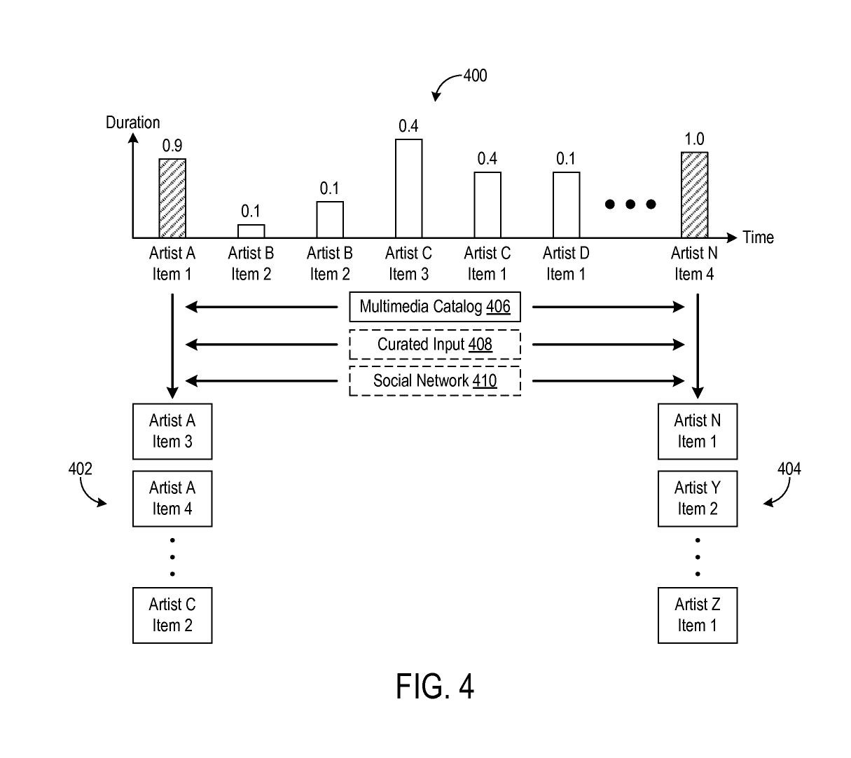

FIG. 4 shows a multimedia consumption history 400 including user-to-artist affinities. In the depicted example, history 400 combines multimedia consumption history 200 (FIG. 2) and the user-to-artist affinities determined in plot 300 (FIG. 3). The determined user-to-artist affinities are shown above each multimedia item associated with their respective multimedia artists. History 400 also includes the preferred artists identified in plot 300, with artists ‘A’ and ‘N’ being the preferred artists specifically shown.

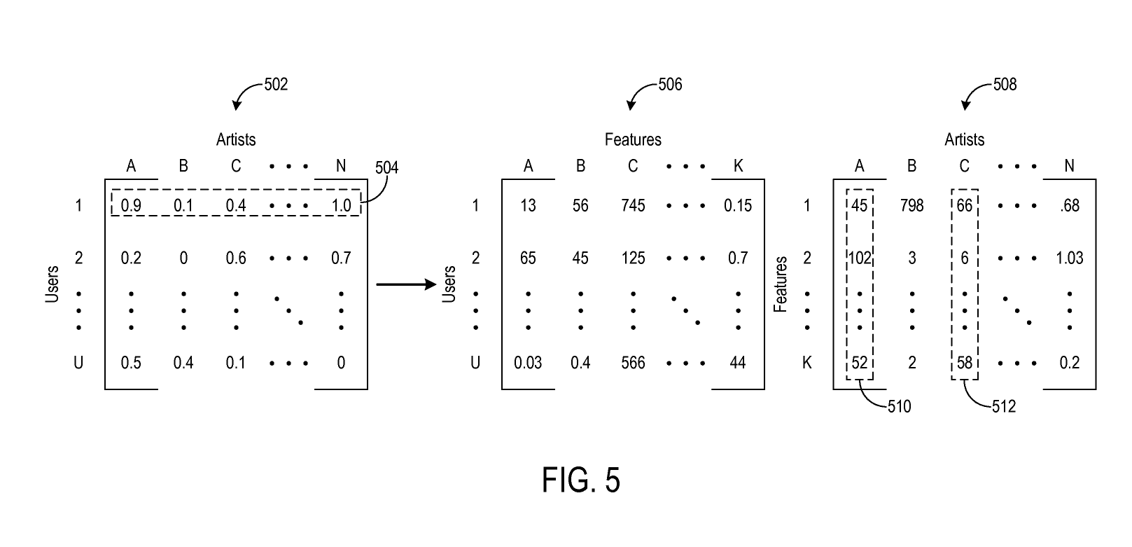

FIG. 4 also illustrates how a set of multimedia recommendation candidates may be recommended to the user associated with multimedia consumption history 400 even if history 400 does not include multimedia consumption history data associated with the set of multimedia recommendation candidates. Rather, the set of multimedia recommendation candidates is determined such that history 400 does include multimedia consumption history data associated with each artist associated with each multimedia recommendation candidate in the set of multimedia recommendation candidates. In some implementations, the set of multimedia recommendation candidates is determined such that history 400 includes an affinity of the user for each artist associated with each of the multimedia recommendation candidates. As described in further detail below with reference to FIG. 5, artist-to-artist similarity may be determined based on user-to-artist affinities to select which multimedia recommendation candidates to recommend to the user.

As shown in FIG. 4, a set of multimedia recommendation candidates 402 whose artists are determined to be similar to preferred artist ‘A’, and a set of multimedia recommendation candidates 404 whose artists are determined to be similar to preferred artist ‘N’, are determined In this way, multimedia recommendation may reflect diverse user taste. In the illustrated example, candidates 402 and 404 both include candidates whose artists are the same as their respective preferred artists with which they were identified—specifically, multimedia items 3 and 4 created by artist ‘A’ are identified based on consumption data associated with item 1 of artist ‘A’, and multimedia item 1 created by artist ‘N’ is identified based on consumption data associated with item 4 of artist ‘N’. Conversely, candidates 402 and 404 also include candidates whose artists are not the same as their respective preferred artists with which they were identified—namely, item 2 of artist ‘C’ identified with artist ‘A’, and item 2 of artist ‘Y’ and item 1 of artist ‘Z’, both identified with artist ‘N’.

Before determining artist-to-artist similarity, multimedia recommendation candidates may be initially identified by accessing a multimedia catalog 406. Catalog 406 may index a plurality of multimedia and may be regularly updated so that new release multimedia may be retrieved from the catalog. Catalog 406 may be maintained by a remote service in communication with a computing device on which multimedia recommendation candidates are determined, though implementations in which a computing device is used to implement both functions are possible.

Additional inputs may be used to inform the multimedia recommendation process. For example, curated input 408 that classifies various aspects (e.g., type, genre, date created, individual contributing artists, etc.) of multimedia in multimedia catalog 406 may be optionally accessed. Curated input 408 may be generated from human input supplied by so-called “multimedia experts”, for example. Such input may be supplied by a user for which multimedia is recommended or other external users.

Alternatively or additionally, data from a social network 410 may be optionally retrieved to inform multimedia recommendation. In this implementation, one or more multimedia consumption histories associated with users other than the user for which multimedia is being recommended may be accessed via social network 410. Each of these external multimedia consumption histories of other users may include affinities for each artist for which consumption data is recorded and/or indications of one or more preferred artists in each consumption history. As described in further detail below, artist-to-artist similarities may be determined by using a plurality of user-to-artist affinities associated with a plurality of users to provide robust multimedia recommendation. Although access to a single social network is shown in FIG. 4, it will be appreciated that two or more social networks may be accessed in the manners described above. In some implementations, data retrieved via social network 410 may be a collection of multimedia consumption data collected via multimedia storefront 100 (FIG. 1) or an external application.

In some examples, an affinity of a user for an artist may represent how prolifically the user has previously experienced one or more complementary multimedia types different from a first multimedia type assumed by the multimedia item with which the affinity is associated. As a non-limiting example, a jazz artist may be identified as a preferred artist for the user due to a high affinity of the user for that artist. The affinity, however, indicates that the user has prolifically experienced several films (e.g., documentaries) related to jazz. The films may be related to the jazz music artist via one or more of multimedia catalog 406, curated input 408, and social network 410, for example. In this way, consumption data recorded for a plurality of disparate multimedia types may be leveraged to recommend multimedia of one or more types.

For implementations in which external multimedia consumption histories are used in recommending multimedia, additional filtering of multimedia consumption data may be performed. For example, artists whose multimedia is consumed by less than a threshold number of users (e.g., two) may be ignored. Alternatively or additionally, multimedia consumption histories of users who listen to less than a threshold number of unique artists (e.g., two) may not be considered. Artists whose average affinities for a number of users are less than a threshold affinity may be ignored. This may be true for a single user such that artists are ignored whose affinities of the user are less than the threshold. These thresholds may be adjusted, for example based on group characteristics of a collection of multimedia consumption histories and users to better enable the usage of meaningful data and discard data that does not meet desired significance.

To select which of a set of multimedia recommendation candidates to recommend to the user, the similarity of preferred artists and those associated with the multimedia recommendation candidates may be determined based on an affinity of the user for the artist associated with a given multimedia recommendation candidate and an affinity of the user for the preferred artist with which the given multimedia recommendation candidate was identified. For example, item 2 of artist ‘C’ of multimedia recommendation candidates 402 may be recommended, as artist ‘C’ is determined to be highly similar to artist ‘A’ with which artist ‘C’ was identified, based on the user affinities to artists ‘A’ and ‘C’.

In some implementations, determining the similarity between a multimedia artist associated with a multimedia recommendation candidate and a preferred artist may include representing the preferred artist with a preferred artist vector, and representing the multimedia artist with a multimedia artist vector. The preferred artist vector may be derived from a collective community experience with the preferred artist, and the multimedia artist vector may be derived from a collective community experience with the multimedia artist. As described in further detail below, a collective community experience with a multimedia artist may be represented by a plurality of user-to-artist affinities of a plurality of different users for that multimedia artist. Then, the similarity between the preferred artist and the multimedia artist may be defined as a dot product of the preferred artist vector and the multimedia artist vector.

In some examples, artist-to-artist similarity may be performed on an iterative basis to drive multimedia recommendation. Specifically, similarities between a multimedia artist associated with a multimedia recommendation candidate and each preferred artist in a set of preferred artists may be determined In this way, the similarities for the multimedia recommendation candidate artist may be determined for all preferred artists in the set of preferred artists. Each of the similarities determined for the multimedia recommendation candidate artist may then be considered together (e.g., summing or averaging individual similarities) to determine a total similarity for the multimedia recommendation candidate artist. The total similarity may then be evaluated to determine whether or not to recommend the multimedia recommendation candidate (e.g., depending on whether the total similarity exceeds a total similarity threshold). Referring to FIG. 4, as a nonlimiting example, similarities between a multimedia recommendation candidate and each of preferred artists ‘A’ and ‘N’ may be determined These similarities may then be summed to determine a total similarity for the multimedia recommendation candidate. In this approach, multimedia recommendation candidates whose artists are similar to a greater number of preferred artists may be recommended more frequently than those whose artists are similar to a relatively lesser number of preferred artists. Approaches in which two or more preferred artists, and not each and every preferred artist in a set of preferred artists, are considered when determining multimedia recommendation candidate similarity are possible, however.

FIG. 5 illustrates an example of the formation of multimedia artist vectors and determination of artist-to-artist similarity. As shown, a user-artist matrix 502 may be determined that includes a plurality of user-to-artist affinities where each affinity is the affinity of a given user for a given artist. The plurality of affinities represent a collective community's experience with a plurality of artists, and may be retrieved from social network 410 (FIG. 4), for example. Each row vector in matrix 502 is a user vector comprising a plurality of affinities of that user to a plurality of artists (e.g., artists ‘A’ through ‘N’)—for example, row vector 504 comprises the affinities of the user whose consumption history and preferred artists were shown in

FIG. 4. The column vectors of matrix 502 accordingly are artist vectors where each artist vector represents the community's collective experience of that artist.

In some scenarios, matrix 502 may include a very large volume of user-to-artist affinities that may reduce the effectiveness of multimedia recommendation—e.g., due to unacceptably high computation cost and/or required storage. Accordingly, matrix 502, and particularly the artist vectors included therein, may be approximated. One such method of matrix approximation is matrix factorization, which may be carried out by various suitable methods including but not limited to stochastic gradient descent and variational Bayes. As shown in FIG. 5, matrix 502 may be approximated as a product of two matrices—a user-feature matrix 506 and a feature-artist matrix 508. In this example, matrix 506 is a U×K matrix and matrix 508 is a K×N matrix, where K is a number of features. K may be selected so that matrix 502 is approximated at an acceptable degree of accuracy and an acceptable computational cost. Having appropriately selected K, the similarity between artists may be determined by computing the dot product of column vectors of matrix 508, as these column vectors are (approximated) artist vectors.

As a non-limiting example illustrating the determination of artist-to-artist similarity by computing the dot product of artist vectors in feature-artist matrix 508, a dot product may be computed between a preferred artist vector 510 corresponding to artist ‘A’ identified as a preferred artist in multimedia history 400 (FIG. 4) and a multimedia artist vector 512 corresponding to artist ‘C’ associated with multimedia recommendation candidate item 1 of artist ‘C’ in multimedia recommendation candidates 402. Matrix 508 resulted from factoring user-artist matrix 502, which comprises a plurality of affinities that represent the collective community experiences with preferred artist ‘A’ and multimedia artist ‘C’. As the dot product yields a similarity between artists ‘A’ and ‘C’ exceeding a threshold, item 2 of artist ‘C’ is recommended. Multimedia recommendation candidates whose similarities with preferred artists do not exceed the threshold may not be recommended, however.

The artist-to-artist similarity threshold may be adjusted in some examples. Increases in the artist-to-artist similarly may increase the relevance of multimedia recommendations, while decreases in the threshold may accommodate a larger number of multimedia preferences for a given user. As a nonlimiting example, the artist-to-artist similarity threshold may be adjusted on a per-user basis and particularly decreased for users that exhibit relatively more diverse multimedia preferences (e.g., preferences that span multiple disparate genres and/or multimedia types). Alternatively or additionally, the artist-to-artist similarity threshold may be increased for users whose consumption of previously recommended multimedia is relatively low so that more relevant multimedia is subsequently recommended.

It will be appreciated that approaches other than matrix factorization may be used to form artist vectors without departing from the scope of this disclosure. Moreover, similarity computations other than artist-to-artist similarity computations may be used to recommend multimedia—e.g., author, director, lead actor, producer, etc. similarities. In some examples, similarity computations of differing multimedia roles may be performed, such as artist-to-author, director-to-actor, etc. Individual artists may be compared where two or more artists created a multimedia item—for example, one or more individual artists may be compared to a preferred artist so that an individual artist's multimedia item released as a solo project may be recommended as a result of identifying that a user preferred a group of artists in which the individual artist participated.

Various approaches may be employed for cases in which no multimedia consumption history for an artist exists. Such a scenario may arise when a multimedia item created by a new artist is retrieved from multimedia catalog 406 (FIG. 4), for example. Here, curated input (e.g., from the user being recommended multimedia or other users) may be used. Alternatively or additionally, the new artist may be temporarily assigned a vector associated with another artist. This vector may be selected also based on curated input, for example.

Multimedia recommendation candidates whose similarities to the preferred artists with which they were identified that exceed a threshold may be filtered before being recommended to a user. For example, a multimedia recommendation candidate may be recommended if the multimedia recommendation candidate has been previously recommended to the user less than a threshold number of times, but not recommended to the user if the multimedia recommendation candidate has been previously recommended to the user more than the threshold number of times. Such an approach may reduce the degree to which the user experiences fatigue when receiving recommendations. This threshold may be adjusted on a per-user or per-user group basis in some examples, for example to account for differences in user tolerance for previously recommended multimedia. Alternatively or additionally, the time period that specifies what is considered a new release may be increased for multimedia recommendation candidates that have been recommended more than the threshold number of times. In some examples, only one multimedia item per artist may be recommended. Moreover, various criteria may be used to break ties in similarities; in some examples, multimedia recommendation candidates having greater durations may be preferred and recommended over those having relatively shorter durations (e.g., long play music albums may be preferred over short play albums, which in turn may be preferred over singles). Some types of multimedia may not be recommended—e.g., music albums whose types correspond to sound effects, karaoke, various artist albums, etc. In some implementations these types may be user-specified.

In some implementations, recommendation candidates may be recommended in a ranked order according to various criteria (e.g., affinity, similarity, etc.). For example, multimedia items 106 presented in window 104 of FIG. 1 may be arranged from left-to-right in an ascending order according to their similarities. The order in which multimedia recommendation candidates are presented may be shuffled as recommendations are presented.

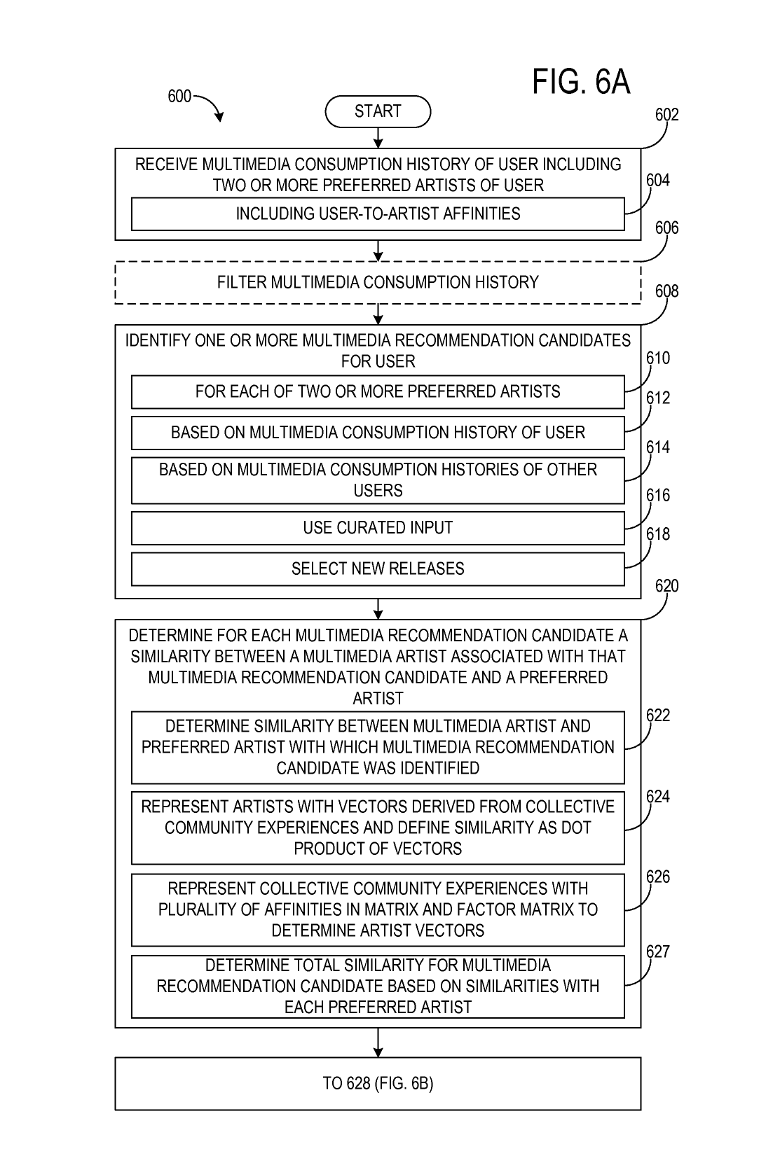

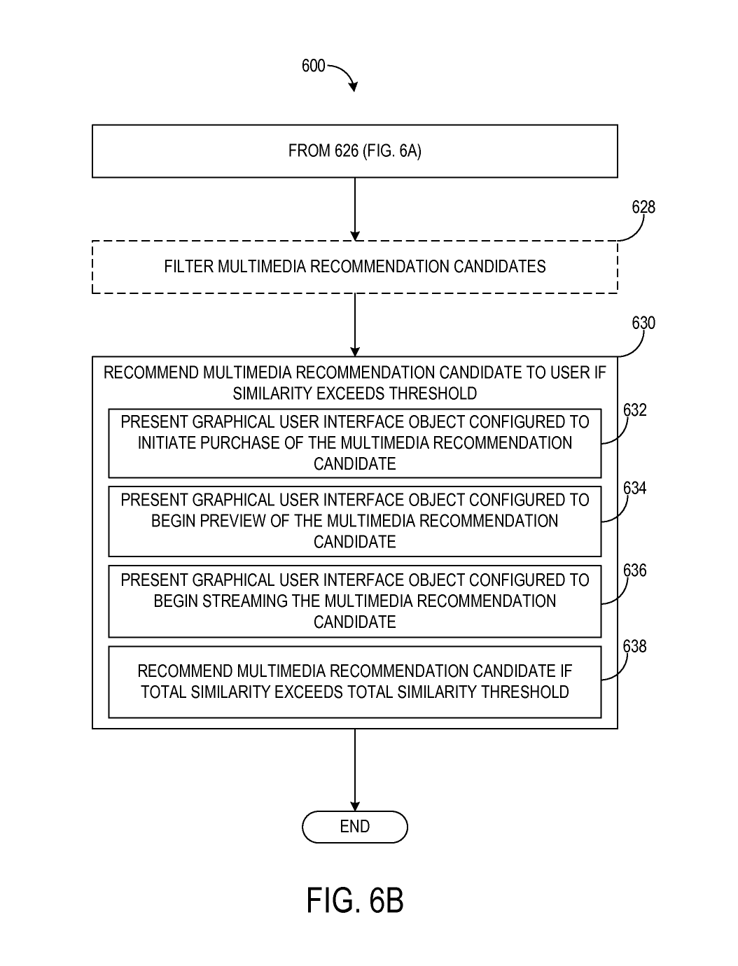

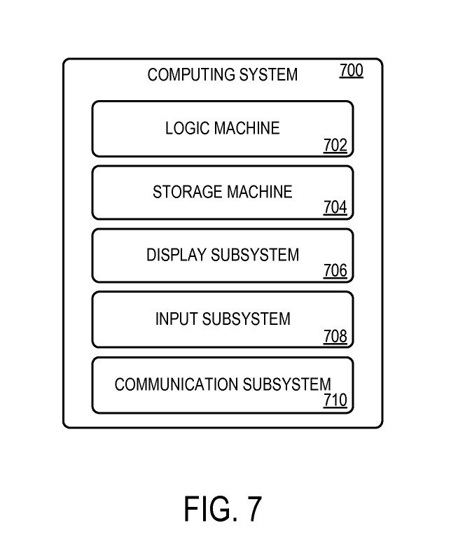

FIGS. 6A and 6B show a flowchart illustrating a method 600 of recommending multimedia. Method 600 may be performed by a suitable computing device such as computing device 700 of FIG. 7 described below, for example.

At 602 of method 600, a multimedia consumption history of a user including two or more preferred artists of the user is received. The history may be received from a remote service, for example. Receiving the history may include, at 604, receiving a history including user-to-artist affinities.

At 606 of method 600, the received multimedia consumption history may be optionally filtered. For example, artists having affinities less than a threshold affinity may be discarded from consideration in subsequent steps. Alternatively or additionally, filtering may be employed to discard artists that are not uniquely identified and/or to remove duplicate and/or near-duplicate consumption data.

At 608 of method 600, one or more multimedia recommendation candidates are identified for the user. Identifying the one or more candidates may include, at 610, identifying one or more multimedia recommendation candidates for each of the two or more preferred artists included in the multimedia consumption history received at 602. Identifying the one or more candidates may include, at 612, identifying the one or more multimedia recommendation candidates based on the multimedia consumption history of the user. The multimedia consumption history may include an affinity of the user for each artist associated with each of the multimedia recommendation candidates. Identifying the one or more candidates may include, at 614, identifying the one or more multimedia recommendation candidates based on multimedia consumption histories of other users (e.g., via a social network). Identifying the one or more candidates may include, at 616, using curated input such that the multimedia recommendation candidates may be curated. Identifying the one or more candidates may include, at 618, selecting newly released multimedia items.

At 620 of method 600, for each multimedia recommendation candidate, a similarity between a multimedia artist associated with that multimedia recommendation candidate and a preferred artist is determined Determining the similarity may include, at 622, determining a similarity between the multimedia artist and a preferred artist with which the multimedia recommendation candidate was identified. Determining the similarity may include, at 624, representing artists with vectors derived from collective community experiences and defining artist-to-artist similarity as a dot product of the vectors. For example, a preferred artist may be represented with a preferred artist vector derived from a collective community experience with the preferred artist, and a multimedia artist may be represented by a multimedia artist vector derived from a collective community experience with the multimedia artist. The similarity between the preferred artist and the multimedia artist may then be defined as a dot product of the preferred artist vector and the multimedia artist vector. Determining the similarity may include, at 626, representing the collective community experiences with a plurality of user-to-artist affinities in a matrix and factoring the matrix to determine the artist vectors. For example, the preferred artist vector and the multimedia artist vector may be vectors in a feature-artist matrix which may be determined by factoring a user-artist matrix into a user-feature matrix and the feature-artist matrix. The user-artist matrix may comprise a plurality of affinities that represent the collective community experiences with the preferred artist and the multimedia artist.

Determining the similarity may include, at 627, determining a total similarity for the multimedia recommendation candidate based on similarities between the multimedia artist associated with the multimedia recommendation candidate and each preferred artist in a set of preferred artists. In other words, a similarity between the multimedia recommendation candidate artist and a preferred artist is determined for each preferred artist in the set of preferred artists. Then, the similarities are considered together to determine the total similarity.

Turning to FIG. 6B, method 600 continues at 628 where the multimedia recommendation candidates may be optionally filtered. For example, multimedia recommendation candidates may be filtered depending on the number of times they have been previously recommended and/or depending on their duration. Moreover, only one multimedia item per artist may be recommended. Multimedia may also be filtered depending on its type (e.g., sound effects, karaoke, various artist albums, etc. may be removed).

At 630 of method 600, a multimedia recommendation candidate is recommended to the user if its similarity exceeds a threshold similarity. Recommending the multimedia recommendation candidate may include, at 632, presenting a graphical user interface object configured to initiate a purchase of the multimedia recommendation candidate. Recommending the multimedia recommendation candidate may include, at 634, presenting a graphical user interface object configured to begin a preview of the multimedia recommendation candidate. Recommending the multimedia recommendation candidate may include, at 636, presenting a graphical user interface object configured to begin streaming of the multimedia recommendation candidate. Recommending the multimedia recommendation candidate may include, at 638, recommending the multimedia recommendation candidate if the total similarity of the multimedia recommendation candidate, determined at 627, exceeds a total threshold similarity.

As shown and described, method 600 may thus be employed to recommend multimedia to a user that better aligns with the multimedia preferences of the user, even if consumption data of the user for the recommended multimedia does not exist, by determining artist-to-artist similarity.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system (e.g., device) 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of recommending multimedia to a user, comprising:
identifying one or more multimedia recommendation candidates for the user;
determining, for each of the one or more multimedia recommendation candidates, a similarity between a multimedia artist associated with that multimedia recommendation candidate and one or more preferred artists of the user; and
recommending that multimedia recommendation candidate to the user if the similarity exceeds a threshold.

2. The method of claim 1, wherein recommending that multimedia recommendation candidate includes presenting a graphical user interface object configured to initiate a purchase of the multimedia recommendation candidate.

3. The method of claim 1, wherein recommending that multimedia recommendation candidate includes presenting a graphical user interface object configured to begin a preview of the multimedia recommendation candidate.

4. The method of claim 1, wherein recommending that multimedia recommendation candidate includes presenting a graphical user interface object configured to begin streaming the multimedia recommendation candidate.

5. The method of claim 1, wherein the one or more preferred artists are identified based on a multimedia consumption history of the user.

6. The method of claim 5, wherein the one or more multimedia recommendation candidates are mated.

7. The method of claim 5, wherein the multimedia consumption history of the user includes an affinity of the user for each artist associated with each of the multimedia recommendation candidates.

8. The method of claim 7, wherein the affinity of the user for an artist represents how prolifically the user has previously experienced multimedia created by the artist.

9. The method of claim 7, wherein multimedia created by an artist is of a first multimedia type, the affinity of the user for the artist representing how prolifically the user has previously experienced one or more complementary multimedia types different from the first multimedia type.

10. The method of claim 5, wherein the one or more multimedia recommendation candidates are identified based on multimedia consumption histories of other users.

11. The method of claim 1, wherein determining the similarity between the multimedia artist and the one or more preferred artists includes:
representing a preferred artist with a preferred artist vector derived from a collective community experience with the preferred artist;
representing the multimedia artist with a multimedia artist vector derived from a collective community experience with the multimedia artist; and
defining a similarity between the preferred artist and the multimedia artist as a dot product of the preferred artist vector and the multimedia artist vector.

12. The method of claim 11, wherein the preferred artist vector and the multimedia artist vector are vectors in a feature-artist matrix, the feature-artist matrix determined by factoring a user-artist matrix into a user-feature matrix and the feature-artist matrix, the user-artist matrix comprising a plurality of affinities that represent the collective community experiences with the preferred artist and the multimedia artist.

13. The method of claim 1, wherein the one or more multimedia recommendation candidates are new releases released within a threshold duration of the identification of the one or more multimedia recommendation candidates.

14. The method of claim 1, wherein recommending the multimedia recommendation candidate includes:
recommending the multimedia recommendation candidate if the multimedia recommendation candidate has been previously recommended to the user less than a threshold number of times; and
recommending a different multimedia recommendation candidate and not the multimedia recommendation candidate if the multimedia recommendation candidate has been previously recommended to the user more than the threshold number of times.

15. A method of recommending multimedia to a user, comprising:
receiving a multimedia consumption history of the user, the multimedia consumption history including two or more preferred artists of the user;
identifying, for each of the two or more preferred artists of the user, a respective set of multimedia recommendation candidates;
determining, for a given multimedia recommendation candidate in a set of multimedia recommendation candidates, a similarity between an artist associated with the given multimedia recommendation candidate and a preferred artist with which the given multimedia recommendation candidate was identified; and
recommending the given multimedia recommendation candidate if the similarity exceeds a threshold.

16. The method of claim 15, wherein the multimedia consumption history of the user does not include multimedia consumption history data associated with the respective set of multimedia recommendation candidates.

17. The method of claim 16, wherein the multimedia consumption history of the user includes multimedia consumption history data associated with each artist associated with each multimedia recommendation candidate in the respective set of multimedia recommendation candidates.

18. The method of claim 15, wherein the similarity is determined based on an affinity of the user for the artist associated with given multimedia recommendation candidate and an affinity of the user for the preferred artist with which the given multimedia recommendation candidate was identified.

19. The method of claim 18, wherein the affinity of the user for the artist associated with the given multimedia recommendation candidate is increasingly weighted as a time since the user consumed multimedia associated with the artist decreases.

20. A method of recommending multimedia to a user, comprising:
identifying one or more multimedia recommendation candidates for the user;
determining, for each of the one or more multimedia recommendation candidates, a similarity between a multimedia artist associated with that multimedia recommendation candidate and one or more preferred artists of the user by comparing a collective community experience with the multimedia artist and a collective community experience with the one or more preferred artists; and
recommending that multimedia recommendation candidate to the user if the similarity exceeds a threshold.
